(19) United States
(12) Patent Application Publication
(10) Pub. No.: US 2009/0153115 A1
(43) Pub. Date: Jun. 18, 2009

(54) DC-DC converter drive circuit which has step up mode and step down mode

(75) Inventor: Kazuo Henmi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/314,140

(22) Filed: Dec. 4, 2008

(30) Foreign Application Priority Data
Dec. 18, 2007 (JP) 2007-325606

(51) Int. Cl. G05F 1/56

(52) U.S. Cl. 323/282

(57) ABSTRACT

A switching signal for load power control undergoes a logic change on the basis of a reference power supply potential by a controller responding to a load power feed control sense signal, and a reference signal. The sense signal in a first operation mode is converted from a load power feed state feedback signal varying on the basis of an input power supply potential into a signal varying on the basis of the reference power supply potential to be fed to the controller. On the other hand, a load power feed state feedback signal varies on the basis of the reference power supply potential in a second operation mode, and the load power feed state feedback signal is used as the sense signal to be fed to the controller.

### BACKGROUND OF THE INVENTION

1. Field of the Invention

The invention relates to a DC-DC converter drive circuit for stepping down, or boosting an input power supply voltage to thereby drive a load, and in particular, to a DC-DC converter drive circuit for stepping down, or boosting an input power supply voltage in order to effectively drive a load at a constant current.

2. Description of Related Art

The DC-DC converter drive circuit is in widespread use as a circuit for driving a load by the agency of a voltage, and/or current, differing from the input power supply voltage, required by the load. The DC-DC converter drive circuit in its basic configuration includes a load and a switching element connected in series to or in parallel with the load, provided between an input power supply voltage feed terminal, and a reference power supply voltage feed terminal. The DC-DC converter drive circuit further includes a voltage/current sensing circuit for generating a sensing signal corresponding to a drive voltage or a drive current, applied to the load, and continuity non-continuity of the switching element is controlled on the basis of the sensing signal of the voltage/current sensing circuit, thereby obtaining a drive voltage, or a drive current, as an object.

A sensing circuit includes one having a sensing resistance connected to a side of a load, adjacent to an input power supply voltage, as shown in Patent Document 1, and one having a sensing resistance connected to a side of a load, adjacent to a reference power supply voltage, as shown in Patent Document 2.

Further, if a voltage required by a load is smaller in value than the input power supply voltage, then it is necessary to step down the input power supply voltage. Conversely, if the voltage required by the load is larger in value than the input power supply voltage, then it is necessary to boost the input power supply voltage. In Patent Documents 3, and 4, there has been shown a DC-DC converter capable of aromatically stepping down or boosting an input power supply voltage according to magnitude of the input power supply voltage.

Still further, since determination on whether an input power supply voltage is to be stepped down or boosted is dependent on a system, there has been disclosed a DC-DC converter capable of selecting one of step-down and boost to thereby operate by locking either of the step-down and the boost, in Patent Document 5.

[Patent Document 1] Japanese Patent Application Laid Open No. HEI7 (1995)-319565

### [Patent Document 2] Japanese Patent Application Laid Open No. 2004-135378

### [Patent Document 3] Japanese Patent Application Laid Open No. 2007-097361

### [Patent Document 4] Japanese Patent Application Laid Open No. 2007-053883

### [Patent Document 5] Japanese Patent Application Laid Open No. 2006-025498

### SUMMARY

A DC-DC converter that automatically steps down or boosts an input power supply voltage according to magnitude of the input power supply voltage has the capability of coping with a variety of systems; however, such a converter becomes complex in configuration, and more expensive. Meanwhile, there exists a strong requirement that although determination on whether the input power supply voltage is stepped down or boosted is dependent on a system to be constructed, if either the step-down or the boost is selectable, this will suffice. From such a point of view, an advantage is gained by the DC-DC converter, as disclosed in Patent Document 5, capable of selecting either of a step-down mode and a boost mode, and executing operation by fixing the operation in an operation mode as selected.

However, with an operation mode changeover system as disclosed in Patent Document 5, there has been adopted a configuration that a sense signal to an error amplifier, and a reference voltage feed terminal are changed according to changeover of the operation mode, so that it is necessary to connect an n-channel MOS transistor serving as the so-called low-side switch to a reference power supply voltage terminal side in the boost mode while it is necessary to connect a p-channel MOS transistor serving as the so-called high-side switch to an input power supply voltage terminal side in the step-down mode. Thus, there is the need for selecting a conductivity type of a MOS transistor to be used according to the operation mode. Furthermore, in the case of a high-side switch configuration, it is required that a drive circuit of the MOS transistor, as well, is of high-voltage specification, so that in the case of circuit integration, a device structure and a process have to be of high-voltage specification, resulting in bloating in chip size.

A DC-DC converter drive circuit according to the invention, includes a controller for generating a switching signal for controlling power supply to a load circuit provided between an input power supply potential and a reference power supply potential by responding to a sense signal and a reference signal, the switching signal undergoing a logic change on the basis of the reference power supply potential, a step-down operation feedback means for receiving a first feedback signal varying on the basis of the input power supply potential from the load circuit in a step-down operation mode to covert the first feedback signal into a signal varying on the basis of the reference power supply potential, and feeding the signal as the sense signal to the controller, and a boost operation mode feedback means for receiving a second feedback signal varying on the basis of the reference power supply potential from the load circuit in a boost operation mode, and feeding the second feedback signal as the sense signal to the controller.

Thus, with the invention, the switching signal for controlling the power supply to a load undergoes a logic change on the basis of the reference power supply potential regardless of an operation mode as selected. That is, a switching device of the so-called low-side configuration can be connected regardless of whether the step-down operation mode is selected or the boost operation mode is selected. However, if the step-down operation mode is selected, then the feedback signal varies on the basis of the input power supply potential from the load circuit, so that the feedback signal as it is cannot be fed as the sense signal to the controller. Accordingly, the feedback signal is converted into a signal varying on the basis of the reference power supply potential to be thereby fed to the controller. On the other hand, if the boost operation mode is selected, then the feedback signal from the load circuit varies on the basis of the reference power supply potential, so that the feedback signal can be utilized as the sense signal to the controller.

As described above, the invention can provide a DC-DC converter capable of utilizing a power transistor of the same conductivity type as a switching element in either the step-down operation mode, or the boost operation mode. Furthermore, even in the case of carrying out circuit integration of a DC-DC converter drive circuit, it is possible to achieve reduction in chip size. At the time of circuit integration, the power transistor can be built therein.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 illustrates a circuit diagram of a DC-DC converter drive circuit according to a first exemplary embodiment of the invention, particularly in a step-down operation mode;

FIG. 2 illustrates a circuit diagram of the DC-DC converter drive circuit according to the first embodiment of the invention, particularly in a boost operation mode;

FIG. 3 illustrates a circuit diagram of a DC-DC converter drive circuit according to a second exemplary embodiment of the invention;

FIG. 4 illustrates a circuit diagram of a DC-DC converter drive circuit according to a third exemplary embodiment of the invention; and

FIG. 5 illustrates a circuit diagram of a DC-DC converter drive circuit according to a fourth exemplary embodiment of the invention.

### DETAILED DESCRIPTION OF THE EXEMPLARY EMBODIMENTS

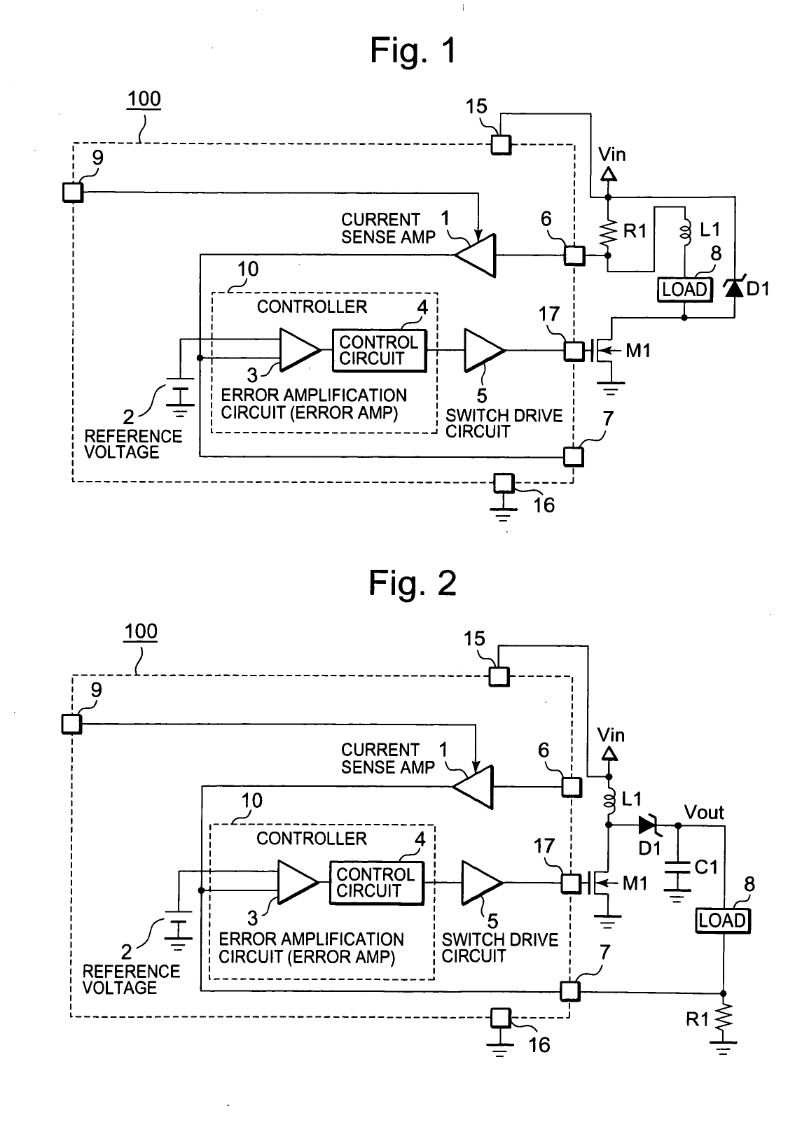

Referring to FIG. 1, a DC-DC converter drive circuit 100 according to a first exemplary embodiment of the invention is made up as an integrated circuit comprised of an input power supply potential feed terminal 15, a reference power supply potential feed terminal 16 denoted as ground, a step-down/boost operation mode changeover control terminal 9, a step-down operation feedback terminal 6, a boost operation feedback terminal 7, and a switching signal output terminal 17. The step-down operation feedback terminal 6 is connected to an input node of a current sense amplifier 1. The current sense amplifier 1 is turned into an operating state when a step-down operation activation signal at High level is applied to the terminal 9, thereby converting a feedback signal from the terminal 6 into a sense signal varying on the basis of a reference power supply potential of the terminal 16 to be fed to a controller 10. On the other hand, when a boost operation activation signal at low level is fed to the terminal 9, the sense amplifier 9 is turned into a deactivation state, and a feedback signal to the terminal 7 is fed as a sense signal to the controller 10.

The controller 10 includes an error amplification circuit (error amplifier) 3, and a control circuit 4, the controller 10 causing a switching signal for driving a load to be generated at the output terminal 17 via a switch drive circuit 5 by responding to the sense signal, and a reference signal from a reference voltage source 2.

In the case of a DC-DC converter of such a configuration described as above, for driving a load at constant current by the agency of a voltage lower than an input power supply potential (in the so-called step-down operation mode), a load circuit as an external circuit of a drive integrated circuit 100 is made up by connecting a switching device M1 such as a power transistor to a resistor R1, an inductor L1, a load 8, and a diode D1, as shown in FIG. 1. More specifically, an outer circuit includes the sense resistor R1 having one end connected to an input power supply Vin at a potential of, for example, 40 V, the inductor L1 connected in series to the sense resistor R1, the load 8 connected in series to the inductor L1, the switching device M1 connected in series to the load 8, and the Schottky barrier diode D1 connected between a node interconnecting the load 8, and the switching device M1, and the input power supply Vin.

Since the switching signal from the terminal 17 has a logic amplitude based on the reference power supply potential, an n-channel MOS transistor is used as the switching device M1, the n-channel MOS transistor having a drain connected to the load 8, a source connected to the reference power supply potential as earth ground, and a gate connected to the terminal 17, respectively. The input power supply potential Vin is connected to the terminal 15 as well.

The load 8 may be an LED device. In such a case, the load 8 may be a plurality of LED devices connected in series, or in parallel with each other. Further, the load 8 may be a heating wire having a resistance component.

Further, the feedback terminal 6 is connected to a node interconnecting the resistor R1, and the inductor L1, and the feedback terminal 7 is set open. A signal at High level is fed to the selection terminal 9 for selection between the step-down/boost operations, so that the current sense amplifier 1 amplifies a difference in potential between respective ends of the sense resistor R1 at a predetermined amplification factor, and converts the difference into a sense signal based on the reference power supply potential.

With the DC-DC converter drive circuit 100, the current sense amplifier 1 is driven by the input power supply Vin, and other components are driven by a power supply lower in voltage than the input power supply Vin. In this case, the same may be generated from the input power supply Vin within the circuit 100. Otherwise, the power supply lower in voltage than the input power supply Vin may be provided by a power supply at a lower voltage, other than the input power supply Vin. Needless to say, those other components may be driven by the input power supply Vin.

The error amplifier 3 amplifies a differential between respective signals inputted to two input terminals thereof to be thereby outputted. In a step-down operation, a differential between an output voltage of the current sense amplifier 1, and the reference voltage 2 is amplified, and an output thereof is connected to an input terminal of the control circuit 4. The control circuit 4 can be a PWM control circuit comprising a signal source for a triangular wave having a given frequency, and a comparator, for adjusting High-level time of a pulse according to an output signal of the error amplifier 3, as inputted, to thereby output a pulse signal. The control circuit 4 may be a PFM control circuit comprising a clock generation source variable in frequency, for outputting a pulse signal variable in frequency according to the output signal of the error amplifier 3. Otherwise, the control circuit 4 may be a PNF control circuit comprising a clock generation source constant in frequency, for controlling the number of pulses according to the output signal of the error amplifier 3.

The output of the control circuit 4 is delivered to the switching device drive circuit 5. The switching device drive circuit 5 has an output part comprising an output resistance necessary for driving the gate of the switching device M1. The switching device M1 is an n-channel MOSFET having a gate drive voltage not higher than 10 V in this exemplary embodiment. In such a case, the switching device drive circuit 5 includes a device having resistance to a voltage not higher than 10 V.

On the other hand, in the case of a DC-DC converter for driving a load at constant current by the agency of a voltage higher than the input power supply potential (in the so-called boost operation mode), an external circuit including a load circuit comprising a switching device is as shown in FIG. 2.

More specifically, one end of an inductor L1 is connected to the input power supply Vin at a potential on the order of, for example, 20 V, and a drain of a switching device M1 is connected to the other end of the inductor L1. Further, the drain of the switching device M1 is connected to an anode of a Schottky barrier diode D1 and a cathode of the Schottky barrier diode D1 is coupled to a capacitor C1, and connected to a load 8, respectively. One end of a sense resistor R1 is connected in series to the other end of the load 8, and the other end of the sense resistor R1 is grounded.

A node interconnecting the sense resistor R1 and the load 8 is connected to the feedback terminal 7. At this point in time, the feedback terminal 6 is open. As a boost operation activation signal at Low level is fed to the selection terminal 9, the current sense amplifier 1 is in a deactivation state, so that the feedback terminal 6 may therefore be connected to the input power supply Vin.

The error amplifier 3 inside the controller 10 receives a signal from the feedback terminal 7 as a sense signal, amplifying a differential between the sense signal and the reference voltage 2. The control circuit 4 responds to a result of error amplification, thereby controlling a switching operation of the transistor M1 via the switching drive circuit 5, and the terminal 17.

Thus, owing to presence of the current sense amplifier 1, and the two feedback terminals 6, 7, the feedback signal from the load circuit, as the sense signal varying on the basis of the reference power supply potential, is fed to the controller 10 in either the step-down operation mode, or the boost operation mode. Accordingly, the terminal 17 is able to obtain a switching signal having a logic change on the basis of the reference power supply potential, so that the need for changing the switching device M1 is eliminated, and the DC-DC converter for execution of a step-down operation, or the DC-DC converter for execution of a boost operation can be provided simply by changing a connective relationship of the load circuit.

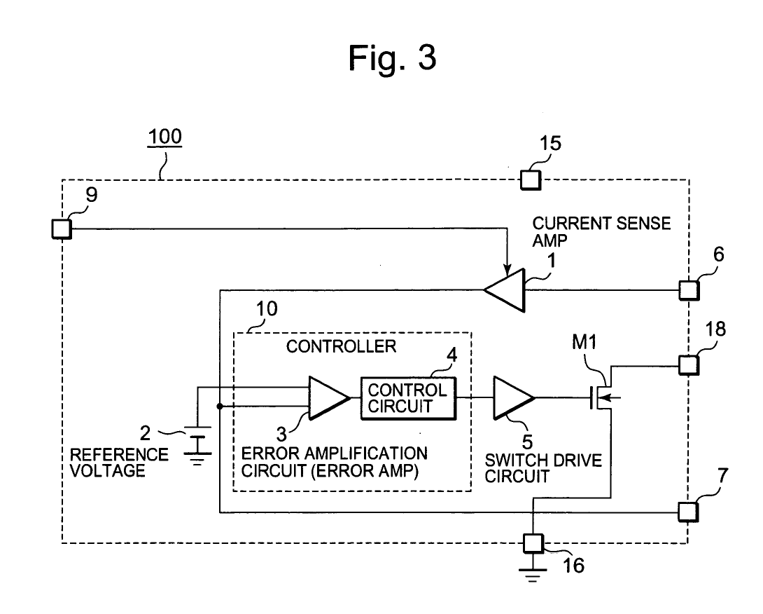

With the first exemplary embodiment as above, the switching device M1 has been shown as an outer component, and the same device can be used in both the step-down operation mode, and the boost operation mode. Accordingly, as a second exemplary embodiment of the invention, it is possible to make up an IC 100 by integrating an n-channel MOS transistor M1 serving as the switching device, and other constituent elements on the same IC package, or on the same chip, as shown in FIG. 3.

The transistor M1 has a drain connected to a terminal 18, and a source connected to a terminal 16, respectively. In the step-down operation mode, the terminal 18 is connected to the node interconnecting the load 8, and the diode D1, shown in FIG. 1, and in the boost operation mode, the terminal 18 is connected to the node interconnecting the inductor L1 and the diode D1, shown in FIG. 2.

With the second exemplary embodiment of the invention, it is possible to gain an advantage in that the number of components of the load circuit, composed of outer components, can be reduced.

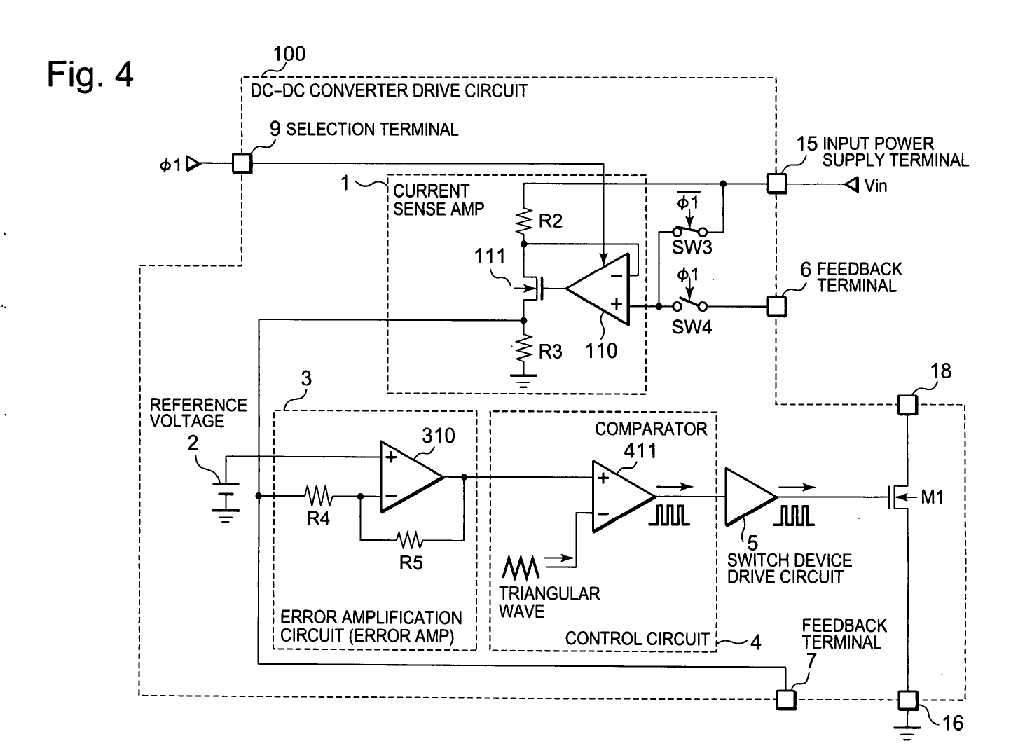

Referring to FIG. 4, there is shown a DC-DC converter drive circuit 100 according to a third exemplary embodiment of the invention. In the figure, the current sense amplifier 1, the error amplifier 3, and the control circuit 4 are shown in further detail. Constituent elements of the DC-DC converter drive circuit 100, identical to those shown in FIGS. 1 to 3, respectively, are denoted by like reference numerals, omitting description thereof.

With the exemplary embodiment, the n-channel MOS transistor M1 serving as the switching device, is shown as one constituent element of an IC, as is the case with FIG. 3, however, the n-channel MOS transistor M1 may be an outer component of the IC, as is with the respective case of FIGS. 1, and 2.

In FIG. 4, the current sense amp 1 includes an operational amplifier 110, a transistor 111, and resistors R2, R3. An output of the operational amplifier 110 is connected to a gate (if the transistor is a bipolar transistor, a base thereof) of the transistor 111. The resistor R2 has one end connected to a source (if the transistor is the bipolar transistor, an emitter thereof) of the transistor 111, and the resistor R3 has one end connected to a drain (if the transistor is the bipolar transistor, a collector thereof) of the transistor 111. The input power supply Vin is connected to the other end of the resistor R2 via the input power supply potential feed terminal 10. The other end of the resistor R3 is grounded. A node interconnecting the resistor R3, and the transistor 111 is an output node of the current sense amp 1. An amplification factor of the current sense amp 1 is dependent on a ratio of a resistance value of the resistor R2 to that of the resistor R3.

Since the configuration including externally connected components, as shown in FIG. 1, is adopted in the step-down operation mode, a signal inputted from the terminal 6 will be at a potential lowered from the input power supply Vin by a voltage drop of the sense resistor R1, however, the current sense amp 1 amplifies the voltage drop by the amplification factor described as above, thereby outputting the potential as a potential based on the ground potential.

With the exemplary embodiment, a switch SW3 is connected between the terminal 15, and the current sense amplifier, and a switch SW4 is connected between the terminal 6, and the current sense amplifier. When a selection signal φ1 inputted to the selection terminal 9 is turned High in the step-down operation mode, the switches SW3, SW4 are turned OFF, ON, respectively. In the boost operation mode, the switches SW3, SW4 are turned ON, OFF, respectively, by the agency of the signal φ1 at Low level.

The error amplifier 3 is comprised of an operational amplifier 310, and resistors R3, R4. Herein, an amplification factor of the error amplifier 3 is dependent on a ratio of a resistance value of the resistor R4 to that of the resistor R5. Further, the reference voltage 2 is applied to one of input terminals of the operational amplifier 310.

Further, a phase compensation capacitor (not shown) may be added for parallel-connection between respective ends of the resistor R5, or for series-connection between one end of the resistor R5, on a side thereof, adjacent to a noninverting input terminal of the operational amplifier, and a node between the resistors R4, R5.

The control circuit 4 includes a comparator 411. A triangular wave is inputted to a minus input terminal of the comparator 411, and an output node of the error amplifier 3 is connected to a plus input terminal thereof. By so doing, an output signal of the error amplifier 3 is compared with a triangular wave signal. As a result, there is executed PWM modulation having a period of the triangular wave, wherein time (so-called “duty”) when a logic level is High level is changed according to a signal level of the output signal of the error amplifier 3.

In the step-down operation mode, the selection signal inputted to the selection terminal 9 is turned High. Further, the configuration of the externally connected components is as shown in FIG. 1.

In so doing, the current sense amp 1 is activated, amplifying a potential difference Vs between the terminals of the sense resistor R1 by a predetermined amplification factor A to be then outputted. As is evident from a circuit configuration shown in FIG. 4, the amplification factor A is R3/R2. An output A·Vs (=R3/R2·Vs) of the current sense amp 1, and the reference voltage 2 are inputted to the error amplifier 3, and a differential therebetween is amplified to be thereby outputted. A pulse signal corresponding to ON•OFF timing of the switching device M1 according to an output of the error amplifier 3 is generated. The pulse signal outputted from the control circuit 4 is outputted to the gate of the switching device M1 via the switching device drive circuit 5 (time constant dependent on the gate capacity of the switching device M1, and the output resistance of the switching device drive circuit 5 is set sufficiently smaller than that when a High-level period of the pulse signal is at the minimum).

When the switching device M1 is ON, current flows from the input power supply Vin to the ground via the sense resistor R1, the inductor L1, the load 8 and the switching device M1. At this point in time, electric energy is stored in the inductor L1.

When the switching device M1 is OFF, the energy stored in the inductor L1 is discharged, so that a potential at a node between the inductor L1, and the load 8 turns High, and current flows from the inductor L1 back to the inductor L1 via the load 8, the Schottky barrier diode D1, and the sense resistor R1.

As a result of the switching device M1 being repeatedly turned ON•OFF, the same current flows through the sense resistor R1, and the load 8. When the voltage drop Vs caused by the current flowing through the sense resistor R is A·Vs=the reference voltage 2 within the DC-DC converter drive circuit 100, negative feedback of a system in whole is stabilized. That is, current (Vref/(A·R1)) dependent on the sense resistor R1, the amplification factor A of the current sense amp, and the reference voltage 2 (=Vref) flows substantially stably through the load 8.

On the other hand, in the boost operation mode, the selection signal at Low level is inputted to the selection terminal 9. By so doing, the current sense amp comes to a stop. Further, the configuration of the externally connected components, in the boost operation mode, is as shown in FIG. 2.

Accordingly, the potential difference Vs between the terminals of the sense resistor R1 is delivered to the error amplifier 3 via the feedback terminal 7. Further, an amplifier circuit (not shown) having an amplification factor A′ may be provided between the feedback terminal 7, and the error amplifier 3. In contrast to the sense resistor R1 having resistance on the order of several ohms, the resistor R3 has resistance on the order of several kilo-ohms, so that an effect of the resistor R3 can be effectively ignored.

The error amplifier 3 compares a signal (Vs) applied to the feedback terminal 7 with the reference voltage 2, amplifying a differential therebetween to be thereby outputted. The pulse signal corresponding to ON•OFF timing of the switching device M1 is generated in the control circuit 4 according to the output of the error amplifier 3. The pulse signal outputted from the control circuit 4 is delivered to the gate of the switching device M1 via the switching drive circuit 5.

When the switching device M1 is ON, current flows from the input power supply Vin to the ground via the inductor L1, and the switching device. At this point in time, electric energy is stored in the inductor L1. As electric energy stored in the capacitor C1 is discharged at this point in time, current flows through the load 8, and the sense resistor R1.

When the switching device M1 is OFF, the energy stored in the inductor L1 is discharged, so that a potential at a node (the drain of the switching device M1) between the inductor L1, and the switching device M1 turns High, and current flows from the inductor L1 to the ground via negative Schottky barrier diode D1, the load 8, and the sense resistor R1. At this point in time, electric energy is stored in the capacitor C1.

As a result of the switching device M1 being repeatedly turned ON•OFF, the same current flows through sense resistor R1, and the load 8. When the voltage drop Vs caused by the current flowing through the sense resistor R1 is Vs=the reference voltage 2 (or A′·Vs=the reference voltage 2) within the DC-DC converter drive circuit 100, negative feedback of the system in whole is stabilized. That is, current (Vref/R1, or Vref/A′·R1) dependent on the sense resistor R1, and the reference voltage 2 (=Vref) flows substantially stably through the load 8.

Thus, there is provided a DC-DC converter capable of supporting both the step-down operation mode, and the boost operation mode, and the switching device, as required, comes in the so-called low-side configuration in either the step-down operation mode, or the boost operation mode to be thereby connected to the ground side. There is no need for interchanging types of the switching device according to the operation mode.

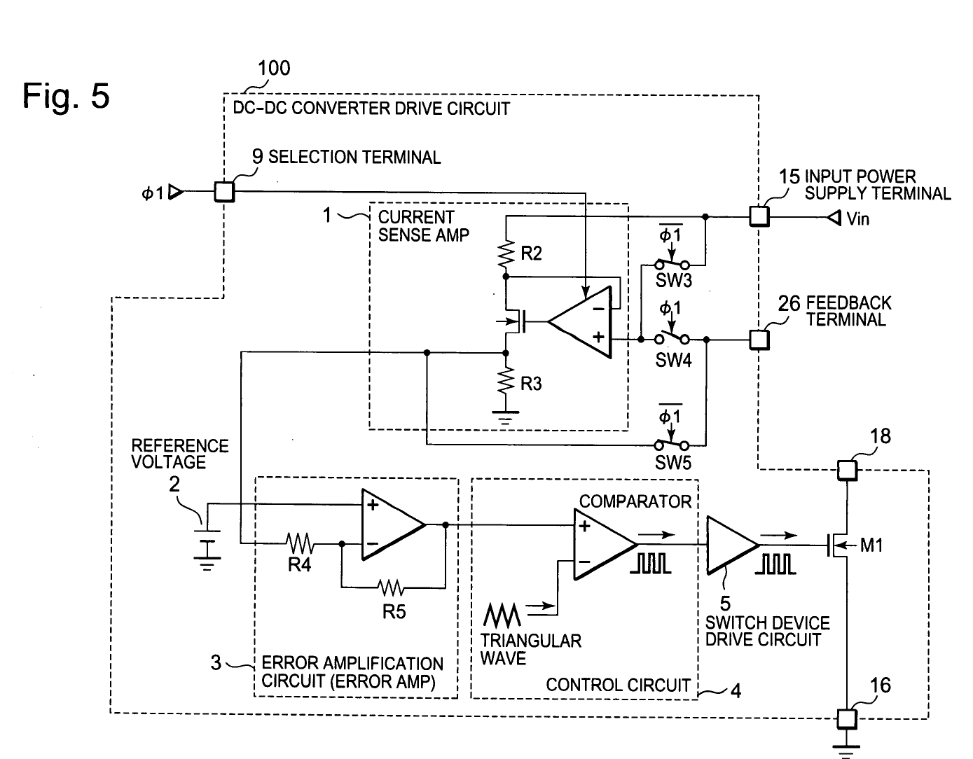

A fourth exemplary embodiment of the invention is shown in FIG. 5. In the figure, description of constituents identical to those in FIG. 4 is omitted.

A DC-DC converter drive circuit 100 according to the fourth exemplary embodiment of the invention is provided with one feedback terminal, namely, only a feedback terminal 6. That is, the feedback terminal 6 is used to double as a feedback terminal for use in the step-down operation mode, and a feedback terminal for use in the boost operation mode. Accordingly, a switch SW5 is provided between the feedback terminal 26, and an output of a current sense amp 1. When the signal φ1 is at Low level, that is, in the boost operation mode, the switch SW5 is turned ON.

With adoption of such a configuration as above, the number of feedback terminals is reduced, contributing to reduction in cost at the time of circuit integration, in particular.

As described in the foregoing, the invention offers an advantage in that a DC-DC converter can be made up by selecting either of the step-down operation mode, and the boost operation mode with the use of one DC-DC converter drive circuit. In addition, the invention offers another advantage in that the same switching device drive circuit 5 can be shared regardless of whether the boost operation mode is selected or the step-down operation mode is selected, and device voltage of the switching device drive circuit can be kept lower than the voltage of the input power supply Vin, so that the switching device drive circuit can be checked in scale.

Further, it is noted that Applicant's intent is to encompass equivalents of all claim elements, even if amended later during prosecution.

What is claimed is:

1. A DC-DC converter drive circuit, comprising:
a controller that generates a switching signal for controlling a power supply to a load circuit provided between an input power supply potential and a reference power supply potential by responding to a sense signal and a reference signal, the switching signal undergoing a logic change on a basis of the reference power supply potential;
step-down operation feedback means for receiving a first feedback signal varying on a basis of the input power supply potential from the load circuit in a step-down operation mode to convert the first feedback signal into a signal varying on the basis of the reference power supply potential, and feeding the signal varying as the sense signal, to the controller; and
boost operation mode feedback means for receiving a second feedback signal varying on the basis of the reference power supply potential from the load circuit in a boost operation mode, and feeding the second feedback signal as the sense signal to the controller.

2. The DC-DC converter drive circuit according to claim 1, wherein the step-down operation feedback means includes a current sense amplifier, and the current sense amplifier is activated in the step-down operation mode, the current sense amplifier being deactivated in the boost operation mode.

3. The DC-DC converter drive circuit according to claim 2, wherein the current sense amplifier includes an operational amplifier, and a resistor having one end connected to the reference power supply potential, and a signal, converted into the signal varying on the basis of the reference power supply potential, is obtained from the resistor.

4. The DC-DC converter drive circuit according to claim 1, wherein the controller includes an error amplification circuit, which includes a first input node connected to an output node of the step-down operation feedback means and the boost operation mode feedback means, and includes a second input node receiving the reference signal.

5. The DC-DC converter drive circuit according to claim 1, wherein the step-down operation feedback means includes a first feedback terminal for receiving the first feedback signal, and the boost operation mode feedback means includes a second feedback terminal for receiving the second feedback signal.

6. The DC-DC converter drive circuit according to claim 5, wherein the first and second feedback terminals each are for shared use, and the first feedback signal is fed to a relevant common terminal in the step-down operation mode and the second feedback signal is fed to the relevant common terminal in the boost operation mode.

7. The DC-DC converter drive circuit according to claim 1,
wherein the load circuit in the step-down operation mode comprises a series-connection circuit including a sense resistor, an inductor, a load and a switching device provided in series between the input power supply potential and the reference power supply potential, and a diode connected in parallel to the series-connection circuit, and
wherein the switching device receives the switching signal to obtain the first feedback signal from the sense resistor.

8. The DC-DC converter drive circuit according to claim 1,
wherein the load circuit in the boost operation mode comprises a series-connection circuit including an inductor, a diode, a load, and a sense resistor, provided in series between the input power supply potential and the reference power supply potential, a switching device provided in parallel with the series-connection circuit, and a capacitor provided in parallel with the series-connection circuit, and
wherein the switching device obtains the second feedback signal from the sense resistor upon receiving the switching signal.

9. The DC-DC converter drive circuit according to claim 7, wherein the switching device is integrated with the controller, the step-down operation feedback means, and the boost operation feedback means.

10. A DC-DC converter drive circuit, comprising on a semiconductor chip:
an amplification circuit which includes a first node coupled to a first external terminal, and a second node applied with a reference voltage, to produce a first signal;
a control circuit which responds to the first signal, to output a control signal;
a drive circuit which outputs a drive signal in response to the control signal; and
a sense amplifier which includes an input coupled to a second external terminal and an output coupled to the first node, and activated by a mode signal.

11. The DC-DC converter drive circuit as claimed in claim 10, further comprising:
an MOS transistor which is coupled between a third external terminal and a fourth external terminal, and includes a control gate receiving the drive signal.

12. The DC-DC converter drive circuit as claimed in claim 10,
wherein the sense amplifier includes:
an operational amplifier including a first input coupled to the second external terminal via a first switch and coupled to a power source terminal via a second switch, and a second input coupled to a third node;
a first resistor coupled between the power source terminal and the third node;
a transistor coupled between the third node and the first node; and
a second resistor coupled between the first node and a reference potential terminal.

13. The DC-DC converter drive circuit as claimed in claim 10,
wherein the first and second external terminals are provided by a common terminal, and a path between the first node and the common terminal is isolated by a first switch, and a path between the sense amplifier and the common terminal is isolated by a second switch.

14. A system for a DC-DC converter drive circuit, comprising:
a resistor, an inductor, a load element, and an MOS transistor connected in series between a power source terminal and a ground source terminal;
a diode provided between a connecting point of the power source terminal and the resistor, and a connecting point of the load element and the MOS transistor, wherein:
the second external terminal of claim 10 is connected to a connecting point of the resistor and the inductor; and
the drive signal of claim 10 is applied to a gate of the MOS transistor.

15. A system for a DC-DC converter drive circuit, comprising:
an inductor, a diode, a load element, and a resistor being connected in series between a power source terminal and a ground source terminal;
a capacitor provided between a connecting point of the diode and the load element and the ground source terminal; and
an MOS transistor provided between a connecting point of the inductor and the ground source terminal, wherein:
the first external terminal of claim 10 is connected to a connecting point of the resistor and the load element; and
the drive signal of claim 10 is applied to a gate of the MOS transistor.

16. The DC-DC converter drive circuit as claimed in claim 10, further comprising:
a third external terminal which inputs the mode signal.
